(19) United States
(12) Patent Application Publication
(10) Pub. No.: US 2008/0040726 A1
(43) Pub. Date: Feb. 14, 2008

(54) Methods and Apparatuses for Implementing Multiple Phase Software

(75) Inventor: Bin Xing, Shanghai (CN)

Correspondence Address: INTEL/BLAKELY, 1279 OAKMEAD PARKWAY, SUNNYVALE, CA, 94085-4040, US

(73) Assignee: INTEL CORPORATION, Santa Clara, CA (US)

(21) Appl. No.: 10/554,663

(22) PCT Filed: Dec. 31, 2004
(86) PCT No.: PCT/CN04/01585

§ 371 Date: Aug. 23, 2007

(51) Int. Cl. G06F 13/14

(52) U.S. Cl. 719/312

(57) ABSTRACT

A multiple phase application implemented as a front-end portion and a back-end portion. The front-end portion of the application serving as an interface between a BIOS or operating system and the back-end portion of the application implemented in the system management mode (SMM). Embodiments of the invention provide a HDP software implemented as a front-end portion that provides an interface between the BIOS and a back-end portion of the HDP software. The back-end portion of the HDP software is implemented in the SMM and contains the HDP mapping algorithm.

### FIELD

Embodiments of the invention relate generally to the field of software and more specifically to methods and apparatuses for implementing multiple phase software.

### BACKGROUND

Multiple phase software (multiple phase application (MPA)) has the characteristic of a life cycle that spans multiple phases of the running system. Typically, such applications must be active before master boot record (MBR) of the boot device is loaded. The MBR, also referred to as the partition sector is the sector containing the logical beginning of a hard disk (HD) that contains the sequence of commands necessary for booting the operating system (OS). Typically, the MPA must continue to be active when the boot loader is running, when the OS is running and after the OS was shutdown.

Moreover, some such MPAs may consume excessive memory relative to the resource-limited environment in which it is implemented.

### Hard Disk Protection Software

A well-known and prevalent example of a MPA is HD protection (HDP) software. HDP software is an application that monitors the traffic between the host system and the disk controllers to protect the data on the HD. This could include recording the logical block addressing (LBAs) of modified disk blocks for incremental backup or restore or could include redirecting the read/write request to other locations on the disk or even other media. For example, if the OS requests a write to a specific block (e.g., block A), the HDP software redirects the write to another block (e.g., block B). Block A, therefore remains in-tact, and the HDP software creates and maintains a mapping table associating block A to block B. When the OS requests block A, the HDP software reads block B instead. Subsequently, if the user decides to abandon the changes to block A, the HDP software simply abandons the mapping table, and block remains in-tact. This allows the previous state to be restored without resetting the system.

Typical HDP software includes a set of independent components, with each component handling a particular phase of the running system. For example, for a PC with a Win98 installed on its HD, a real mode INT13 (BIOS interrupt provided to access the HD) hook must be provided to redirect or record the read/write request from the OS loader. Then after the OS kernel and its disk driver has been loaded, a filter driver must be present to continue what the INT13 hook was doing. If the Win98 is shutdown and the PC put back into DOS environment, the filter driver has to notify the INT13 hook to reinitialize itself. Other OSs (e.g., Windows XP, Linux, etc.) have their own associated drivers.

FIG. 1 illustrates a system implementing a boot process for an HDP software in accordance with the prior art. System 100, shown in FIG. 1, includes a basic input/output system (BIOS) 102 that initializes the system hardware. The BIOS 102 requests the MBR through INT13 hook 105, which uses INT13 107 to access the HD 120, to boot disk operating system (DOS) 104. The DOS 104 requests OS kernel and driver files through INT13 hook 105 to boot the Windows98 OS 106 which accesses the HD 120 through its integrated drive electronics (IDE) driver 112. The IDE filter driver 110 filters the traffic between the Windows98 OS and the IDE driver 112. The INT13 hook 105 and IDE filter driver 110 intercept the read/write request, find out the redirecting LBA, and use the original INT13 107 or IDE driver 112 to access the HD 120 on behalf of the OS or application.

At his point the Windows98 106 could be shut down and the system returned to DOS mode (DOS 108). If the IDE filter driver (or INT13 hook) is shut down, the successor has to be notified, for example, by means of state flags, so that it can be initialized properly. For example, prior to shutting down Windows98 106, the IDE filter driver 110 must set flags on the HD 120 to notify the INT13 hook (INT13 hook 115) to reload the mapping table through use of INT13 116, in order to keep the internal state of the INT13 hook consistent with the disk. The process is shown in dashed lines in FIG. 1.

As illustrated by typical HDP software, multiple phase software has several disadvantages. One disadvantage is that individual software components have to be developed for each distinguished environment and the components function independent. For example, the same algorithm for providing HDP has to be implemented in multiple different software platforms. When one component is to be shut down, it has to notify its successor. But because components cannot communicate with each other directly, other communication channels must be used (e.g., reserved blocks on the disk or other dedicated hardware in the host system). Moreover, both the INT13 hook and the IDE filter driver have to be rewritten whenever a new or better algorithm is adopted. Also, for some environments (e.g., DOS), system resources are limited due to use of Real mode that uses a 16-bit segmented memory address space (meaning that only 1 MB of memory can be addressed) where for compatibility switching to protected mode is not practical Because the INT13 hook has to work in real mode, where the system resources are very limited, the implementation of the algorithm using the INT13 hook may be more complicated than using the IDE filter driver.

### BRIEF DESCRIPTION OF THE DRAWINGS

The invention may be best understood by referring to the following description and accompanying drawings that are used to illustrate embodiments of the invention. In the drawings:

FIG. 1 illustrates a boot process for an HDP software in accordance with the prior art;

FIG. 2 illustrates a process by which a MPA is implemented in accordance with one embodiment of the invention;

FIG. 3 illustrates a system in which a MPA is divided into a front-end portion and a back-end portion in accordance with one embodiment of the invention; and

FIG. 4 is a block diagram illustrating one embodiment of a digital processing system that may be used in conjunction with various embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

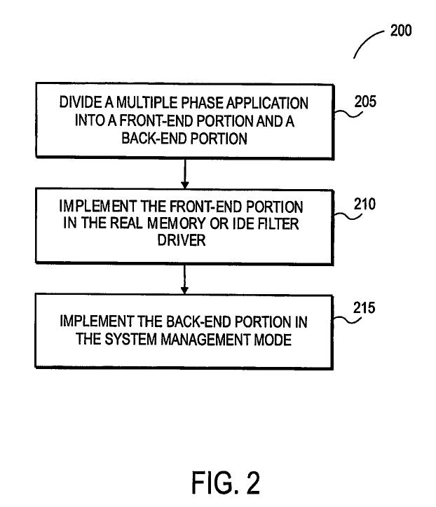

FIG. 2 illustrates a process by which a MPA is implemented in accordance with one embodiment of the invention. Process 200, shown in FIG. 2, begins at operation 205 in which the MPA is divided into a front-end portion and a back-end portion. The front-end portion functions as an interface to accept a request from the BIOS or the OS loader and forward the request to the back-end portion which processes the request.

At operation 210 the front-end portion is implemented in, for example real mode memory (for an INT13 hook) or, for example, the OS kernel address space (for an IDE filter driver).

At operation 215 the back-end portion is implemented in the system management mode (SMM). Implementing the back-end portion of the MPA in the SMM will be discussed more fully below. The SMM is a reduced power consumption state supported by IA32 CPUs. When a CPU enters SMM it saves its current state in a special area of static random access memory (RAM) called system management RAM (SMRAM) which is reserved by the platform firmware upon initialization and hidden from the OS until system reset. Because it has its own memory, the SMM provides an isolated execution environment that operates transparently to the OS.

The system management interrupt (SMI) is an OS-transparent interrupt, it is not stored in the interrupt vector table (IVT). The SMI cannot be triggered by any instruction, but is instead raised by the chipset to cause the CPU to enter SMM mode and the SMI handler to be executed. The SMI is the highest priority interrupt, and therefore cannot be interrupted again.

The SMI handler could instruct the CPU to leave SMM by executing an RSM instruction, which reads the CPU state data from a state save map and restores the CPU state. Because the CPU context at the time the SMI is raised is automatically saved, and restored after leaving SMM, the SMM is transparent to OS.

Thus one embodiment of the invention allows a MPA to be implemented as two distinct portions, a front-end interface and a back-end algorithm. For example, a HDP software may implemented as an HDP algorithm (such as redirecting read/write request) could be implemented in the SMM as the back-end of an HDP suite, while other components (e.g., INT13 hook or IDE filter driver in OS) are implemented as front-end interfaces, which intercept the read/write request and pass them to the back end for further processing.

For one embodiment of the invention, the back-end portion of the MPA is shared among multiple front-end portions. For such an embodiment, the bulk of the MPA, for example the core part of an HDP software (e.g., the HDP algorithm) may be implemented only once in the SMM, thereby saving front-end memory and simplifying the multiple front-end portions. That is, for example, the same algorithm need not be implemented in the INT13 and again in the OS driver. In prior art systems when the OS boots up, for example, Windows98, it won't use the INT13 again, it will use its own disk driver, therefore a prior art HDP software scheme has to provide the driver for Windows98 with the same algorithm that is implemented in the INT13. This redundancy is eliminated in accordance with one embodiment of the invention.

In accordance with one embodiment of the invention, as discussed above, the SMI has only one internal state and cannot be interrupted and all of the internal states are in the SMM (neither the INT13 nor the OS driver has to maintain the internal state. This eliminates the synchronization problem inherent in prior art schemes. That is, in prior art schemes, some applications may use INT13 to access the HD while others use the OS drivers to access the HD. Because the OS is multitasking, the internal state of the INT13 hook and the internal state of the driver become unsynchronized. This lack of synchronization is overcome by embodiments of the invention.

For one embodiment of the invention in which the back-end portion of the MPA contains the bulk of the complicated processing of the MPA, each of multiple front-end portions need not communicate with each other because they do not have to maintain any context information. Each of the front-end portions of the MPA passes the user input to the back-end portion of the MPA. The logic contained in the front-end portions is limited and therefore does not consume excessive system resources.

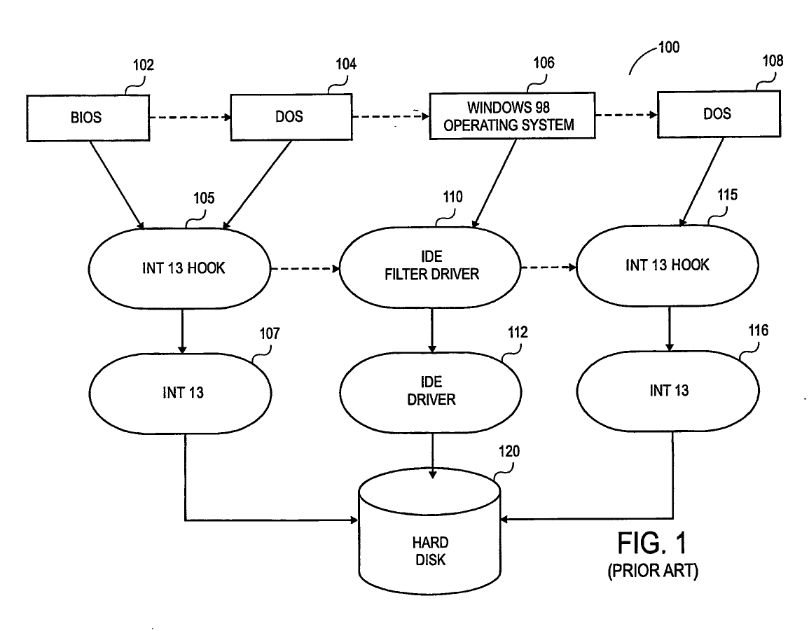

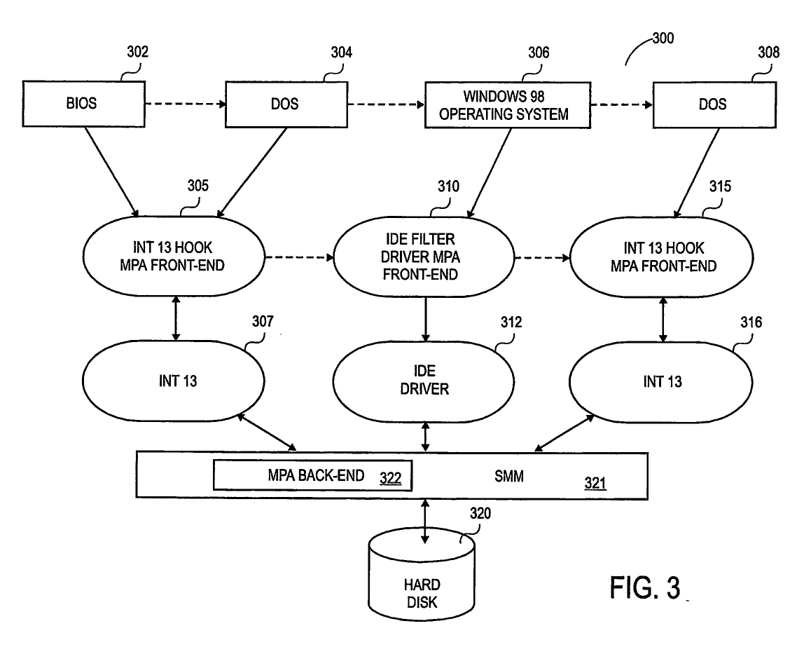

FIG. 3 illustrates a system in which a MPA is divided into a front-end portion and a back-end portion in accordance with one embodiment of the invention. System 300, shown in FIG. 3, is analogous to system 100, described above in reference to FIG. 1. Like reference numbers describe similar components.

As described above, in accordance with one embodiment of the invention, the MPA is divided into a front-end portion and a backend portion. The INT13 hook 305 and IDE filter driver 310 are the front-end portions of the MPA. For example, the INT13 hook 305 is still implemented in real mode, but acts as an interface to assert an I/O request from the BIOS 302 or DOS 304. For one embodiment of the invention the OS could be any OS that accesses the HD through an INT13 and is run in real mode, including DOS or an OS loader (e.g., NT loader or Linux needle). The INT13 hook 305 (MPA front-end) does not process the I/O request itself, but communicates the I/O request, using an SMI, to the MPA back-end portion 322 implemented in SMM 321 for processing. That is, the front-end portion intercepts the I/O request and indicates to the back-end portion what is to be done with the I/O request. The back-end portion then, analyzes the I/O request and tells the front-end portion how to effect the request. The front-end portion leverages the INT13 (e.g., INT13 307, INT13 316) in real mode to fulfill the I/O request.

Likewise, the IDE filter driver 310 is still implemented in the OS kernel address space and functions as an interface between the OS 306 and the MPA back-end portion 322 implemented in SMM 321. The DOS 104 requests OS kernel and driver files the INT13 hook 305 to boot OS 306. For OS, the front-end portion leverages the IDE driver (e.g., IDE driver 312) to fulfill the I/O request.

The INT13 hook 305 or the IDE filter driver 310 may have to communicate multiple I/O requests from the BIOS or OS, respectively, to the MPA back-end portion 322. For example, the MPA back-end portion 322 may contain an application algorithm that requires access to data structures (e.g., an HDP algorithm mapping table) that are stored on HD 320. The INT13 hook 305 or IDE filter driver 310 may receive a write request pertaining to specific data blocks. The INT13 hook 305 or IDE filter driver 310 then communicates that request to the SMM 321. The MPA back-end portion 322 checks if the requested data blocks are protected, if so, the MPA back-end portion 322 will load the mapping entries from the HD 320 if that entry does not exist in memory at that time. Therefore, the MPA back-end portion 322 may issue further requests (not included in the original I/O request) to access the required data. That is, because the SMM 321 may not be able to access hard disk 320, directly, the MPA back-end portion 322 will request an MPA front-end portion to read or write some data on behalf of the MPA back-end portion 322. As shown in Figure the MPA back-end portion 322 may access the HD 320 directly, but practically the MPA back-end portion 320 may instruct an MPA front-end portion to access the HD 320 on its behalf due to compatibility issues in accessing the HD 320 from SMM 321.

Once the MPA back-end portion 322 has all of the required data, the received request is processed. The MPA back-end portion 322 will then communicate the results of the processing to the INT13 hook 305 (or IDE filter driver 310).

For one embodiment of the invention, system 300, shown in FIG. 3, is used to implement a HDP application. For such an embodiment, the MPA front-end portions no longer maintain any mapping table related information. Rather, the back-end portion, implemented in the SMM, contains the mapping table algorithm, which is shared by all front ends. Therefore, the front-end portions do not have to communicate with each other.

Moreover, for one such embodiment, the INT13 hook or IDE filter driver is much easier to implement and consumes much less resources in comparison to prior art schemes, because the HDP algorithm is not implemented in the INT13 hook or IDE filter driver, but in the SMM instead. The increased memory in the SMM (i.e., relative to real mode memory) allows more complex HDP algorithms to be implemented. Where prior art schemes in which the HDP software was implemented in real mode had limited features due to the limited memory (i.e., 1 MB), embodiments of the invention have access to the greater memory capacity of the SMM. For example a prior art scheme may provide redirection of read requests in the INT13 hook so that Windows NT or Linux could boot properly. Such schemes however may not provide redirection of write requests because OS loaders (e.g., Linux needle, NT loader, etc.) seldom write to the HD. Implementing the HDP algorithm in the SMM allows the INT13 hook to provide all of the features of the IDE filter driver in the OS (e.g., write redirect).

The additional memory also allows the HDP algorithm to be written in a high level language (e.g., C programming language) rather than assembly language which was typical in prior art schemes due to memory constraints. Moreover, because the HDP algorithm is implemented only once in the SMM and shared by multiple front-end portions, debugging is easier and less time consuming.

### General Matters

Embodiments of the invention have been described that provide a HDP software implemented as a front-end portion that provides an interface between the BIOS and a back-end portion of the HDP software. The back-end portion of the HDP software is implemented in the SMM and contains the HDP mapping algorithm. However, it will be apparent to those skilled in the art that embodiments of the invention are applicable to a variety of MPAs.

In accordance with one embodiment of the invention, the HDP software is implemented under DOS without additional hardware support while maintaining compatibility. Embodiments of the invention allow for implementation of low-cost HDP software without impacting performance the increased costs of prior art schemes (e.g., add-in cards).

Embodiments of the invention include methods having various operations, many of which are described in their most basic form, but operations can be added to or deleted from any of the methods without departing from the basic scope of the invention. The operations of various embodiments of the invention may be performed by hardware components or may be embodied in machine-executable instructions as described above. Alternatively, the operations may be performed by a combination of hardware and software. Embodiments of the invention may be provided as a computer program product that may include a machine-readable (machine-accessible) medium having stored thereon instructions, which may be used to program a computer (or other electronic devices) to perform a process according to embodiments of the invention as described above.

A machine-accessible medium includes any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

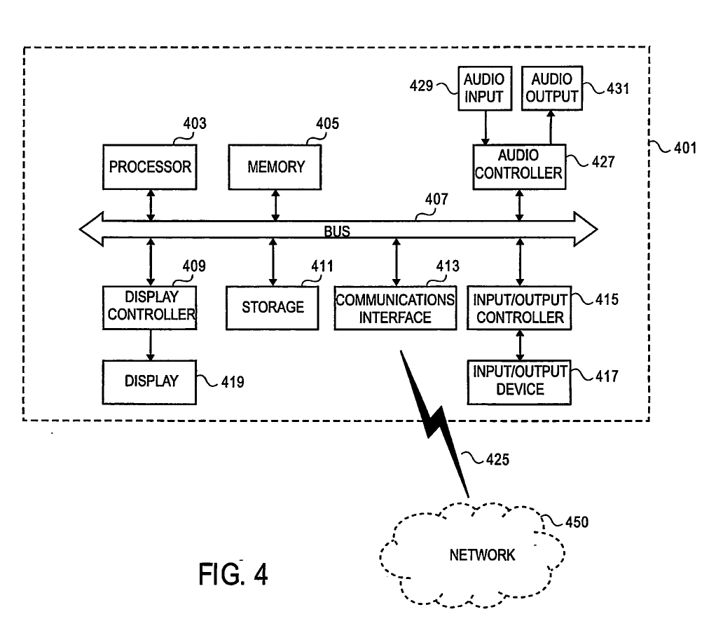

FIG. 4 is a block diagram illustrating one embodiment of a digital processing system that may be used in conjunction with various embodiments of the invention. For alternative embodiments of the present invention, DPS 401 may be a computer that includes a processor 403 coupled to a bus 407. In one embodiment, memory 405, storage 411, display controller 409, communications interface 413, input/output controller 415 and audio controller 427 are also coupled to bus 407.

DPS 401 interfaces to external systems through communications interface 413. Communications interface 413 may include a radio transceiver compatible with wireless telephone signals or other interfaces for coupling a device to other devices. In one embodiment of the present invention, carrier wave signal 425 is received/transmitted between communications interface 413 and network 450. In one embodiment of the present invention, a communications signal 425 may be used to interface DPS 401 with another computer system, a network hub, router or the like. In one embodiment of the present invention, carrier wave signal 425 is considered to be machine readable media, which may be transmitted through wires, cables, optical fibers or through the atmosphere, or the like.

In one embodiment of the present invention, processor 403 may be a conventional microprocessor, such as for example but not limited to an Intel ×86 or Pentium family microprocessor, a Motorola family microprocessor, or the like. Memory 405 may be a machine-readable medium such as dynamic random access memory (DRAM) and may include static random access memory (SRAM). Display controller 409 controls in a conventional manner a display 419, which in one embodiment of the invention may be a cathode ray tube (CRT), a liquid crystal display (LCD), an active matrix display, a television monitor or the like. The input/output device 417 coupled to input/output controller 415 may be a keyboard, disk drive, printer, scanner and other input and output devices (e.g., a mouse). In one embodiment of the present invention, audio controller 427 controls in a conventional manner audio output 431 and audio input 429.

Storage 411 may include machine-readable media such as for example but not limited to a magnetic hard disk, a floppy disk, an optical disk, a smart card or another form of storage for data. In one embodiment of the present invention, storage 411 may include removable media, read-only media, readable/writable media or the like. Some of the data may be written by a direct memory access process into memory 405 during execution of software in computer system 401. It is appreciated that software may reside in storage 411, memory 405 or may be transmitted or received via modem or communications interface 413. For the purposes of the specification, the term “machine readable medium” shall be taken to include any medium that is capable of storing data, information or encoding a sequence of instructions for execution by processor 403 to cause processor 403 to perform the methodologies of the present invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A system comprising:
a processing system control application providing I/O requests;
an interface portion of a multiple phase application;
a processing portion of a multiple phase application, the processing portion of the multiple phase application stored in a system management mode, and processing I/O requests received through the interface portion of the multiple phase application.

2. The system of claim 1 wherein the processing portion of a multiple phase application communicates a result of processing an I/O request to the interface portion of the multiple phase application.

3-4. (canceled)

5. The system of claim 2 wherein the processing system control application is an operating system using an integrated drive electronics (IDE) interface and the interface portion of the multiple phase application is implemented in an operating system kernel address space.

6. The system of claim 2 wherein the processing portion of the multiple phase application is written in a high-level programming language.

7. The system of claim 6 further comprising:
one or more additional interface portions of the multiple phase application wherein the processing portion of the multiple phase application processes I/O requests received through multiple interface portions of the multiple phase application.

8. The system of claim 7 wherein the multiple phase application is a hard disk protection (HDP) application.

9. The system of claim 8 wherein the HDP application includes an HDP algorithm mapping table contained in the processing portion of the HDP application.

10. The system of claim 9 wherein the HDP application includes write redirect functionality.

11. A method comprising:
receiving an I/O request from a processing system control application at an interface portion of a multiple phase application;
communicating the I/O request to a processing portion of a multiple phase application, the processing portion of the multiple phase application stored in a system management mode; and
processing the I/O request received through the interface portion of the multiple phase application at the processing portion of the multiple phase application.

12. The method of claim 11 further comprising
communicating a result of processing an I/O request from the processing portion of a multiple phase application to the interface portion of the multiple phase application.

13-14. (canceled)

15. The method of claim 12 wherein the processing system control application is an operating system using an integrated drive electronics (IDE) interface and the interface portion of the multiple phase application is implemented in an operating system kernel address space.

16. The method of claim 12 wherein the processing portion of the multiple phase application is written in a high-level programming language.

17. The method of claim 16 further comprising:
receiving I/O requests from one or more additional interface portions of the multiple phase application; and
processing the I/O requests received from one or more additional interface portions of the multiple phase application at the processing portion of the multiple phase application.

18. The method of claim 17 wherein the multiple phase application is a hard disk protection (HDP) application.

19. The method of claim 18 wherein the HDP application includes an HDP algorithm mapping table contained in the processing portion of the HDP application.

20. The method of claim 19 wherein the HDP application includes write redirect functionality.

21. An article of manufacture comprising:
a machine-accessible medium having associated data, wherein the data, when accessed, results in a machine performing operations comprising:
receiving an I/O request from a processing system control application at an interface portion of a multiple phase application;
communicating the I/O request to a processing portion of a multiple phase application, the processing portion of the multiple phase application stored in a system management mode; and
processing the I/O request received through the interface portion of the multiple phase application at the processing portion of the multiple phase application.

22. The article of manufacture of claim 21 further comprising
communicating a result of processing an I/O request from the processing portion of a multiple phase application to the interface portion of the multiple phase application.

23-24. (canceled)

25. The article of manufacture of claim 22 wherein the processing system control application is an operating system using an integrated drive electronics (IDE) interface and the interface portion of the multiple phase application is implemented in an operating system kernel address space.

26. The article of manufacture of claim 22 wherein the processing portion of the multiple phase application is written in a high-level programming language.

27. The article of manufacture of claim 26 further comprising:
receiving I/O requests from one or more additional interface portions of the multiple phase application; and
processing the I/O requests received from one or more additional interface portions of the multiple phase application at the processing portion of the multiple phase application.

28. The article of manufacture of claim 27 wherein the multiple phase application is a hard disk protection (HDP) application.

29. The article of manufacture of claim 28 wherein the HDP application includes an HDP algorithm mapping table contained in the processing portion of the HDP application.

30. The article of manufacture of claim 29 wherein the HDP application includes write redirect functionality.
